(19) United States
(12) Patent Application Publication
(10) Pub. No.: US 2008/0112657 A1
(43) Pub. Date: May 15, 2008

(54) Linear guide device and method for designing or forming raceway groove thereof

(75) Inventor: Masaru AKIYAMA, Maebashi-shi (JP)

Correspondence Address: SUGHRUE-265550, 2100 PENNSYLVANIA AVE. NW, WASHINGTON, DC, 20037-3213, US

(73) Assignee: NSK LTD., Tokyo (JP)

(21) Appl. No.: 11/907,762

(22) Filed: Oct. 17, 2007

Related U.S. Application Data
(62) Division of application No. 10/659,260, filed on Sep. 11, 2003, now abandoned.

(30) Foreign Application Priority Data
Sep. 12, 2002 (JP) 2002-267105

(51) Int. Cl. F16C 29/06

(52) U.S. Cl. 384/45

(57) ABSTRACT

In the case that raceway grooves of a guide rail and a slider are formed by rolling, supposing that Dg is the depth of each of the raceway grooves formed by the rolling, and Dw is a diameter of the rolling element, a ball diameter ratio (Dg/Dw), which is a value obtained by dividing the groove depth Dg by a diameter Dw of the rolling element, is set to range from 0.26 to 0.45.

### BACKGROUND OF THE INVENTION

1. Field of the Invention

The present invention relates to a linear guide device for use in an industry machine, in which a raceway groove is formed in particular by rolling, and to a method of designing or forming a raceway groove thereof.

2. Description of the Related Art

A linear guide device having a guide rail extending in an axial direction, and also having a slider straddling the guide rail in such a way as to be able to move in the axial direction has been known. Linear raceway grooves extending in the axial direction are respectively formed in both side surface portions of the guide rail. Linear raceway grooves respectively opposed to the raceway grooves of the guide rail are respectively formed in inner surface parts of both sleeve portions of the slider.

Meanwhile, the raceway grooves of the rail and the slider are usually finished by performing a grinding process as a finishing step after materials are processed by performing a drawing process. However, the grinding process has problems in that processing time is long, and that processing cost is high.

JP-A-2001-227539 discloses a method of forming the raceway grooves by applying rolling techniques to the formation of a linear groove as a countermeasure. This method uses rotary dies having projection-shaped working portions formed on the circumferential part thereof so that the shape of each of the projection-shaped working portions is matched to the shape of an associated one of the raceway grooves. According to this method, the raceway grooves are formed by pressing the projection-shaped working portions from both sides of a rail blank material.

However, in the case of forming raceway grooves by rolling, the shape of each of the raceway grooves, which is transferred to a rail blank material, includes an error due to springback with respect to the shape to be formed by the rotary die. The shape of each of the grooves is further changed by being heat-treated. For example, such an error and variation thereof tend to increase as a processed amount (that is, cost of processing) increases.

When such an error and variation thereof occur in the shape of the raceway groove, the contact angle between the raceway groove and a rolling element does not have a targeted value. This affects the load capacity of the linear guide device, and results in reduction of stiffness thereof, and thus in decrease of the lifetime thereof.

When the processed amount is decreased, that is, the depth of the raceway groove is set to be too shallow so as to reduce the error, a contact ellipse formed in a contact portion between the raceway groove and the rolling element is broken in the middle thereof. Consequently, a contact surface pressure becomes locally excessively large. This results in early damage in the apparatus.

### SUMMARY OF THE INVENTION

Accordingly, the invention is accomplished in view of the aforementioned circumstances. An object of the invention is to provide a linear guide device enabled to ensure processing accuracy needed for satisfactorily performing a bearing function in the case of forming raceway grooves in a guide rail and a slider by rolling, and also enabled to have practically sufficient load capacity, and to provide a method of designing or forming raceway grooves in such a linear guide device.

To achieve the foregoing object, according to an aspect of the invention, there is provided a linear guide device comprising a guide rail extending in an axial direction and having a first raceway groove extending in the axial direction, and a slider having a second raceway groove opposed to the first raceway groove of the guide rail and being supported by the guide rail in such a way as to be able to move along the axial direction through rolling of a large number of rolling elements inserted between the first and second raceway grooves. At least one of the first raceway groove of the guide rail and the second raceway groove of the slider is formed by rolling. A ball diameter ratio (Dg/Dw) obtained by dividing the depth Dg of the raceway groove, which is formed by rolling, by the diameter Dw of each of the rolling elements ranges from 0.26 to 0.45.

According to another aspect of the invention, there is provided a method of designing at least one of raceway grooves of a guide rail and a slider of a linear guide device, which is to be formed by rolling by using a rotary die having a projection-shaped working portion, whose shape is matched to a shape of the raceway groove on which rolling elements roll. According to this method, a depth of the raceway groove to be rolled is set to have a value determined by allowing for an error in shape of the raceway groove, which is caused by the rolling.

According to an embodiment of this method, a depth Dg of the raceway groove to be rolled is set so that a ball diameter ratio (Dg/Dw) obtained by dividing the depth Dg by a diameter Dw of each of the rolling elements ranges from 0.26 to 0.45.

As described above, according to the invention, in the case that the raceway grooves of the guide rail and the slider, which are formed by rolling, supposing that Dg is the depth of each of the raceway grooves formed by the rolling, and Dw is a diameter of the rolling element, the ball diameter ratio (Dg/Dw), which has a value obtained by dividing the groove depth Dg by the diameter Dw of the rolling element, is set to range from 0.26 to 0.45.

Thus, even when the rolled amount is large, an error in shape of the groove is restricted within a certain range by setting the value of the depth of the groove so that the ball diameter ratio is equal to or less than 0.45. On the other hand, even when the depth of the groove is small, load capacity enough for practical use is realized by setting the value of the depth of the groove so that the ball diameter ratio is equal to or more than 0.26.

### BRIEF DESCRIPTION OF THE DRAWINGS

FIG. 1 is a perspective view showing the configuration of a linear guide device that is an embodiment of the invention;

FIG. 2 is an exploded perspective view showing the configuration of a slider of the linear guide device;

FIG. 3 is a sectional view of the linear guide device, taken in the direction of arrows A-A shown in FIG. 1;

FIG. 4A is a schematic side view showing a primary part of a rolling apparatus of rail raceway grooves;

FIG. 4B is a schematic front view showing the primary part of the rolling apparatus of rail raceway grooves;

FIG. 5 is a view used for describing the depth of a raceway groove formed by rolling;

FIG. 6 is a characteristic graph showing the relation between a ball diameter ratio and a contact angle error; and

FIG. 7 is a characteristic graph showing the relation between the ball diameter ratio and a maximum contact surface pressure.

### DETAILED DESCRIPTION OF THE INVENTION

Hereinafter, an embodiment of the invention is described in detail with reference to the accompanying drawings.

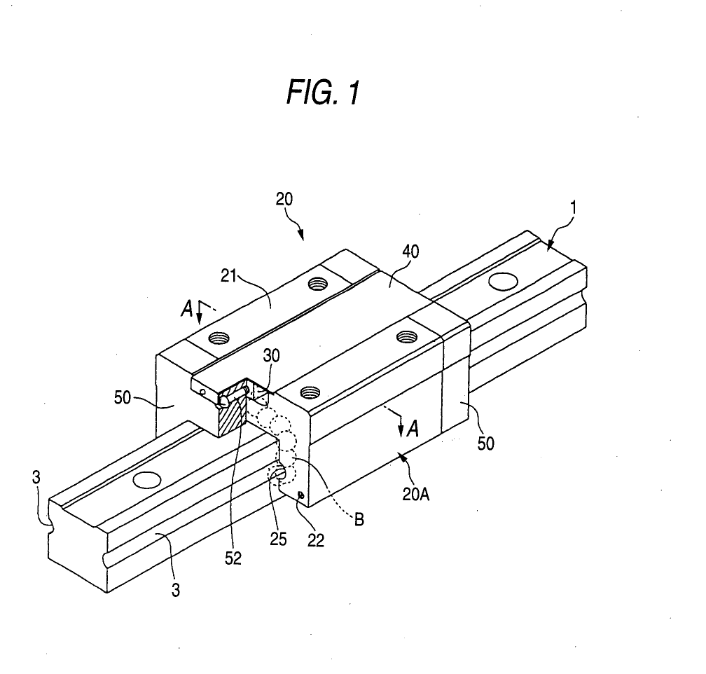

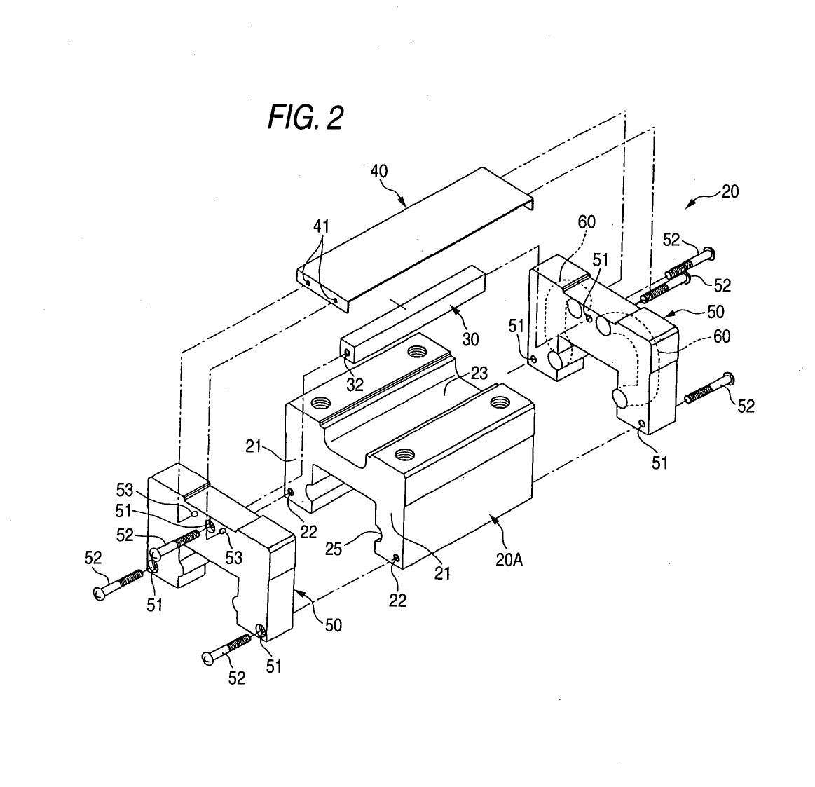

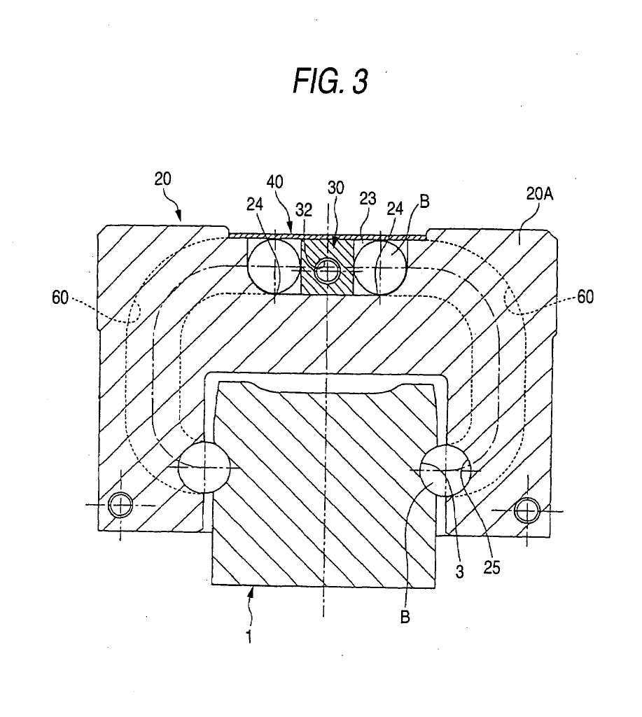

FIG. 1 is a perspective view showing the configuration of a linear guide device that is an embodiment of the invention. FIG. 2 is an exploded perspective view showing the configuration of a slider of the linear guide device. FIG. 3 is a sectional view of the linear guide device, taken in the direction of arrows A-A shown in FIG. 1.

The linear guide device has a guide rail 1 extending in an axial direction, and a slider 20 straddling the guide rail 1 in such a way as to be able to move in the axial direction.

The guide rail 1 is a bar-like element having a nearly square section. Linear raceway grooves 3 extending in the axial direction are formed in both side surface portions of the guide rail 1, respectively. Incidentally, the raceway grooves 3 are formed by rolling. The depth of each of the raceway grooves 3 has a value selected so that the value of a ball diameter ratio ranges from 0.26 to 0.45. This will be described in detail later.

On the other hand, the slider 20 has a slider body 20A and end caps (that is, rolling element circulating components) 50 respectively fixed to both end surfaces of the slider body 20A.

The slider body 20A has a nearly-U-shaped section. Linear raceway grooves 25 respectively opposed to the raceway grooves 3 are formed in the inner surface parts of sleeve portions 21 of this slider body 20A. Screw holes 22 are formed on both end surface parts of the sleeve portions 21 of the slider body 20A, respectively.

Incidentally, the raceway grooves 25 of this slider body 20A and the raceway grooves 3 of the guide rail 1 constitute grooves, on which balls B acting as rolling elements roll. A contact angle α between the ball B and each of the raceway grooves 25 of the slider body 25 and the raceway grooves 3 of the guide rail 1 is set to be 45° so that the values of the load capacity thereof respectively corresponding to four directions, that is, upward, downward, rightward and leftward directions, as viewed in these figures, are equal to one another. Thus, each of the raceway grooves 25 and 3 is formed in such a manner as to have a v-shaped section, that is, a section shaped like a Gothic arch. For instance, the raceway grooves 25 are finished by performing a grinding process.

A groove portion 23 passed in the axial direction through the top surface portion 23 of the slider body 20A is formed therein. The bottom surface of the groove portion is a flat horizontal surface. The section of a part provided between the bottom surface and both inner side surfaces of the groove portion 23 has a shape matched to the shape of a chamfered section of the sphere of the ball B. A separator 30 serving as an elongated member having a square section is disposed nearly at the central part of the groove portion 23. Screw holes 32 are formed coaxially in, for instance, both end surface portions of the separator 30, respectively.

Two rows of rolling element passages 24 corresponding to the raceway grooves 3 and 25 are formed on both sides of the separator 30 on the groove portion 23 by placing such a separator 30 nearly at the central part of the groove portion 23.

Each of the end caps 50 has a nearly U-shaped section, similarly to the slider body 20A. In each of the end caps 50, rolling element circulating portions 60 each linking an associated one of the raceway grooves 3 and 25 with an associated one of the rolling element passages 24 are formed in such a way to upwardly and downwardly extend in a curved manner. Moreover, in each of the end caps 50, screw insertion holes 51 are formed at positions respectively corresponding to a screw hole of the separator 30 and screw holes 22 of the slider body 20A.

Such end caps 50 are disposed at both end portions of the slider body 20A, and fixed to both end surfaces of the slider body 20A by tightening screws 12, which are inserted from the screw insertion holes 51 of the end cap 50, into the screw holes 22 and 32.

After the end caps 50 are fixed to both end surfaces of the slider body 20A, the groove portion 23 (thus, the rolling element passages 24) of the slider body 20A is covered with a cover (that is, a slip-off preventing member) 40. The cover 40 is shaped nearly like a rectangle, and formed in such a way as to be slightly longer than the axial length of the slider 20. Both end portions of the cover are folded downwardly approximately 90°. Two attaching holes 41 are formed in each of the folded portions. The attaching holes 41 are fitted onto projections 53 formed on each of outer surfaces of the end caps 50 corresponding to the attaching holes 41. Consequently, the cover 40 is detachably fixed onto the top surface of the slider 20.

The raceway grooves 3 and 25 made by providing such a slider 20 on the guide rail 1 to be opposed to each other are linked with each other through the rolling element passages 24 of the slider body 20A and the rolling element circulating portions 60 of the end caps 50. Thus, an endless circulating raceway path is constituted. Many balls B are loaded in this endless circulating raceway path in such a way as to be able to roll thereon. Consequently, the slider 20 is enabled to move along the axial direction on the guide rail 1 through the rolling of the balls B.

Next, the formation of the raceway grooves 3 of the guide rail 1 by rolling is described hereinbelow.

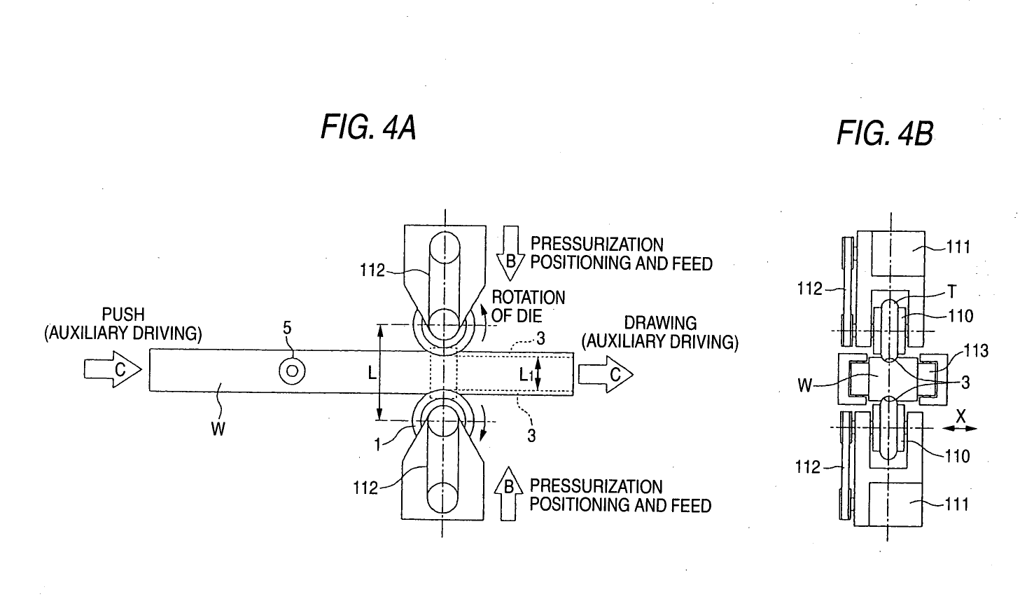

FIGS. 4A and 4B are schematic views of a rolling apparatus of forming the raceway grooves 3 of the guide rail 1 by rolling. FIG. 4A is a side view showing the rolling apparatus of rail raceway grooves. FIG. 4B is a front view thereof. Two rotary dies 110 for rolling are provided in such a manner as to face each other and as to sandwich a work W that is a blank material of the guide rail 1.

Each of the rotary dies 110 is a disk-like circular die, and disposed so that the direction of an axis of rotation thereof is perpendicular to the axial direction of the work W. The shape of the outer peripheral surface (that is, the groove processing surface) of each of the dies is a convex shape matched to the shape of each of the raceway grooves 3 of the guide rail 1, which is rolled. Concretely, each of the dies is shaped like a convex Gothic arch, and constitutes a projection-shaped working portion T.

A die rotating motor 111 serving as a drive device is annexed to each of the rotary dies 110. Each of the rotary dies 110 is driven by this motor 111 through a belt 112 to rotate (that is, the rotary dies 110 are active dies). The apparatus has a movement pressurization mechanism (not shown) for pushing the rotary dies 110 against the work M by moving the rotary dies 110 together with the motors 111 toward the work W in the direction of an arrow B, as indicated in the figure.

The rotary dies 110 fed to a pressurization position by the movement pressurization mechanism is adapted to perform positioning thereof by being butted against a stopper (not shown) or by having a known hydraulic NC or BS drive type positioning and feeding mechanism.

The apparatus further has a positioning and supporting device 113 of, for instance, the hydraulic or fixed type that holds the work W at a processing position from both sides thereof and presses and supports the work W so as to stabilize the position of the work W in the direction of an arrow X (that is, a direction obtained by shifting the phase of a direction, in which the dies are opposed to each other, by 90°) during forming grooves.

Such a rolling apparatus forms the raceway grooves 3 of the guide rail as follows.

Before processed, the work W is preliminarily annealed in such a way as to have hardness HRC 20 or lower. Because a thin decarburized layer is present on the surface of the work W, when the work W is rolled without removing the decarburized layer, sufficient surface quenched hardness of the work W cannot be obtained after the work W is heat-treated. Therefore, before the work W is rolled, the decarburized layer provided on the work W is previously scraped off therefrom by a thickness of about 0.5 mm.

Then, the movement pressurization mechanism (not shown) feeds each of opposed and paired rotary dies 110 to a pressurization position. Subsequently, the positioning of opposed and paired rotary dies 110 is performed by causing the opposed and paired rotary dies 110 to butt against the stopper. Thus, the distance L between the dies is preliminarily set in such a way as to correspond to a known distance L1 between the raceway grooves 3, 3 provided on both sides of the work W.

Then, during the rotary dies 110 are rotated, the work W is inserted between the rotary dies 110. Subsequently, during held at the accurate processing position by the positioning and supporting device 13, the work W is fed in a direction of an arrow C and then passed through between the rotary dies 110. Thus, the raceway grooves 3 of the guide rail are rolled on the side surfaces of the work W.

Incidentally, there are two cases of finishing the work W into a final shape. One is a case that the work W is finished into the final shape by passing the work W through the rotary dies 110 once. The other is a case that the work W is finished into the final shape by passing the work W therebetween a plurality of times while changing the distance between the rotary dies. The number of times of passing of the work W therethrough is determined depending upon the kind of the blank material of the work W and the processing accuracy and shapes of the grooves.

Thus, the raceway grooves 3 of the guide rail 1 are formed by rolling. At that time, the designing of the raceway grooves is designed by determining the depth of each of the grooves so that the ball diameter ratio ranges from 0.26 to 0.45. This is described hereinbelow.

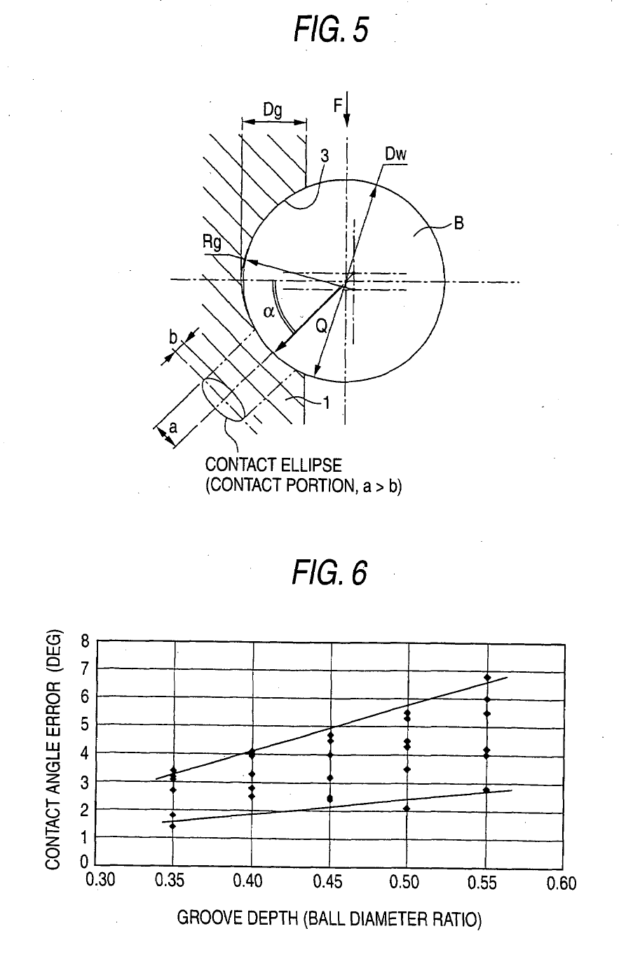

Incidentally, as illustrated in FIG. 5, the ball diameter ratio is defined to be a value (Dg/Dw) obtained by dividing the depth, which is denoted by Dg, of the grooves by the diameter, which is designated by Dw, of the rolling element.

First, the reason for determining the depth of each of the grooves 3 in such a way as to set the upper limit value of the ball diameter ratio at 0.45 is described hereinbelow.

In the case of forming the raceway grooves by rolling, as the processed amount (that is, the depth of each of the grooves) increases, an error due to springback between the shape of each of the actually formed grooves and the target shape to be formed by the rotary dies, and variation thereof increase. Incidentally, the relation between the ball diameter ratio and the error of the contact angle (illustrated in FIG. 5) is obtained as illustrated in FIG. 6.

Meanwhile, the relation among an external load F upwardly or downwardly acting upon the bearing, the contact angle α, and a load (that is, a ball load) Q acting on the contact portion between the rolling element (that is, a steel ball) and each of the raceway grooves in a direction of a normal is given by the following equation (1):

Q=F/sin α (1)

The ball loads obtained according to this equation in the case that an error of 5° with respect to the contact angle of 45° occurs under a constant external load are listed below.

TABLE 1

| | Relative Ball Load |
|---|---|
| | (Ball Load at Contact Angle |
| Contact Angle α [deg] | of 45° Is Assumed to Be 1) |
| 40 | 1.10 |
| 45 | 1 |
| 50 | 0.92 |

As is described in this table, when the contact angle α is changed from 45° to 40° by 5°, the ball load increases 10%. Thus, a burden imposed on each of the raceway grooves increases. When the contact angle α is changed from 45° to 50° by 5°, the ball load decreases in the case of the upward or downward load imposed on the bearing. However, in the case of imposing a transverse load on the bearing, this corresponds to the case that the ball load at the contact angle of 40°. That is, the ball load increases 10%.

Therefore, when it is a target to limit an error of the ball load to 10% or less, an error of the contact angle should be 5% or less. As is understood from the relation illustrated in FIG. 6, appropriate depths of the grooves are obtained in the case that the ball diameter ratio is equal to or less than 0.45.

On the other hand, when the depth of each of the grooves is reduced, the contact ellipse formed in the contact portion between the raceway groove and the rolling element is broken in the middle thereof under a high load. Consequently, a contact surface pressure becomes locally excessively large. This results in early damage in the apparatus. Therefore, it is necessary to ensure a certain level of the depth of each of the grooves. Thus, 0.45 is selected as an upper limit value of the ball diameter ratio.

Incidentally, the contact ellipse is an area constituted by the contact portion between the raceway groove and the rolling element, as illustrated in FIG. 5.

Next, the reason for determining the depth of each of the grooves 3 in such a way as to set the lower limit value of the ball diameter ratio at 0.26 is described hereinbelow.

When the depth of the groove is reduced, an error between the shape of each of the actually formed grooves and the target shape decreases. Conversely, when the depth of each of the grooves is excessively reduced, under a high load, the contact ellipse formed in the contact portion between the raceway groove and the rolling element is liable to be broken. However, when the contact ellipse is broken in the middle thereof, a contact surface pressure becomes locally excessively large. This results in early damage in the apparatus. Consequently, preferably, the depths of the grooves are small. However, it is desirable that the depths of the grooves are small to the extent that the contact ellipse is not broken even under a high load.

Meanwhile, a static rated load is provided as a maximum allowable load of the linear guide device. Thus, it is considered to determine the depth of each of the grooves on condition that the linear guide device withstands the static rated load, which is the upper limit of the load acting upon the contact portion so that the contact ellipse is not broken.

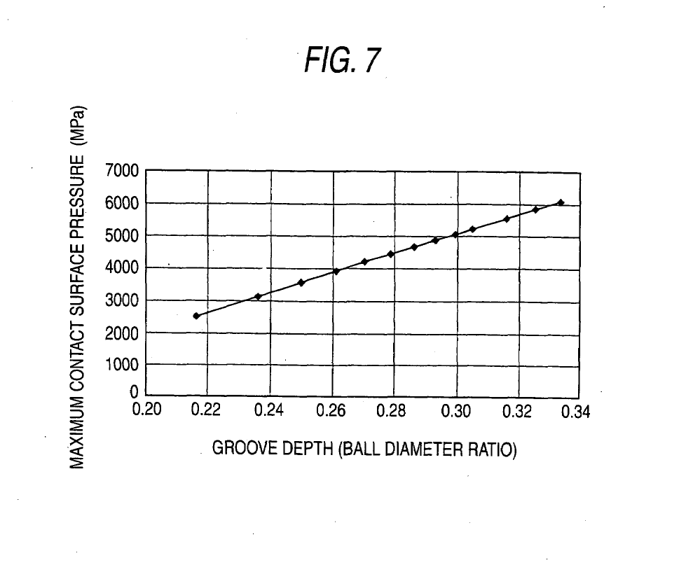

Incidentally, the relation between the ball diameter ratio and the maximum contact surface pressure as illustrated in FIG. 7 is obtained. Additionally, it is usual that a groove radius ratio obtained by dividing a radius Rg of the raceway groove by the diameter Dw of the rolling element is set to range from 51% to 56%. There is a tendency that the larger this groove radius ratio, the higher the surface pressure. Thus, it should be considered the case that the relation illustrated in FIG. 7 is obtained at a groove radius ratio of 56%, at which the surface pressure reaches a maximum value, in the range of the groove radius ratio from 51% to 56%.

Usually, the maximum surface pressure of the contact portion between the raceway groove and the rolling element in the case of imposing a load, which is equivalent to the static rated load, on the bearing is about 4000 MPa. Thus, the load corresponding to the maximum contact surface pressure is set to be the upper limit of the load acting upon the contact portion so that the contact ellipse is not broken. As is seen from the relation illustrated in FIG. 7, the ball diameter ratio of 0.26, at which the associated maximum contact pressure is 4000 MPa, is set to be the lower limit value of the ball diameter ratio corresponding to the depth of each of the grooves.

For the foregoing reasons, when the raceway grooves of the linear guide device are designed, the depth of each of the raceway grooves 3 of the guide rail 1, which is formed by rolling, is determined so that the associated ball diameter ratio ranges 0.26 to 0.45.

Consequently, the invention can provide a linear guide device enabled to reduce processing time, which is taken by rolling raceway grooves, to decrease the cost, to ensure processing accuracy needed for satisfactorily performing functions of the apparatus, and to have a value of the depth of each of the raceway grooves 3, which is determined so that the associated ball diameter ratio ranges 0.26 to 0.45, thereby to have load capacity sufficient for practical use.

Incidentally, in the foregoing description of the embodiment, it has been described the case that the raceway grooves are formed by rolling. However, the raceway groove of the slider 20 (more specifically, the slider body 20A) may be formed by rolling. In this case, the depth of the raceway groove formed in the slider 20 by rolling is determined so that the ball diameter ratio (Dg/Dw) ranges from 0.26 to 0.45. Needless to say, the configuration and arrangement of the rolling apparatus are adapted to form the raceway groove in the slider 20.

Although the configurations of the linear guide device and the rolling apparatus are concretely described in the foregoing description of the embodiment, the invention is not limited thereto. Needless to say, the invention can be applied to a linear guide device and a rolling apparatus, which have other configurations.

As described above, according to the invention, a raceway groove is formed in a guide rail or a slider by rolling. Moreover, the depth of the raceway groove is set so that the ball diameter ratio (Dg/Dw) ranges from 0.26 to 0.45. Consequently, the invention can provide a linear guide device enabled to reduce processing time and cost, to ensure processing accuracy needed for satisfactorily performing functions of the apparatus, and to have load capacity sufficient for practical use.

What is claimed is:

1. A method of designing at least one of raceway grooves of a guide rail and a slider of a linear guide device, which is to be formed by rolling by using a rotary die having a projection-shaped working portion, whose shape is matched to a shape of the raceway groove on which rolling elements roll, the method comprising:
setting a depth of the raceway groove to be rolled, so as to have a value determined by allowing for an error in shape of the raceway groove, which is caused by the rolling.

2. The method according to claim 1, wherein a depth Dg of the raceway groove to be rolled is set so that a ball diameter ratio (Dg/Dw) obtained by dividing the depth Dg by a diameter Dw of each of said rolling elements ranges from 0.26 to 0.45.

3. A method for forming at least one of raceway grooves of a guide rail and a slider of a linear guide device, the method comprising:
preparing at least one rotary dies including a projection-shaped working portion, whose shape is matched to a shape of the raceway groove on which rolling elements roll; and
rolling the raceway groove on a blank material of at least one of the guide rail and slider having the raceway groove to be rolled by the rotary dies, so that a ball diameter ratio (Dg/Dw) obtained by dividing a depth Dg of said raceway groove, which is formed by rolling, by a diameter Dw of each of said rolling elements ranges from 0.26 to 0.45.

4. The method according to claim 5, further comprising:
removing a decarburized layer from a surface of at least one of the guide rail and the slider which has the raceway groove to be rolled.
